(19) United States
(12) Patent Application Publication
(10) Pub. No.: US 2003/0211371 A1
(43) Pub. Date: Nov. 13, 2003

(54) Fuel delivery system and method of use thereof

(76) Inventor: Alfred I-Tsung Pan, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/140,934

(22) Filed: May 9, 2002

(51) Int. Cl. H01M 8/04

(52) U.S. Cl. 429/13; 429/34; 220/565

(57) ABSTRACT

Fuel delivery system and method for delivering liquid fuel to an electrode in a liquid-type fuel cell are disclosed. The liquid fuel is passively delivered to a reaction surface of an electrode by capillary force through a porous structure. The porous structure has a shape and a capillary force distribution to facilitate fuel flow, and can be part of a fuel cartridge for easy transportation and storage of fuel.

### TECHNICAL FIELD

The technical field generally relates to fuel cells and in particular to fuel delivery system for liquid-type fuel cells.

### BACKGROUND

A fuel cell is an electrochemical apparatus wherein chemical energy generated from a combination of a fuel with an oxidant is converted to electric energy in the presence of a catalyst. The fuel is fed to an anode, which has a negative polarity, and the oxidant is fed to a cathode, which, conversely, has a positive polarity. The two electrodes are connected within the fuel cell by an electrolyte to transmit protons from the anode to the cathode. The electrolyte can be an acidic or an alkaline solution, or a solid polymer ion-exchange membrane characterized by a high ionic conductivity. The solid polymer electrolyte is often referred to as a proton exchange membrane (PEM).

In fuel cells employing liquid fuel, such as methanol, and an oxygen-containing oxidant, such as air or pure oxygen, the methanol is oxidized at an anode catalyst layer to produce protons and carbon dioxide. The protons migrate through the PEM from the anode to the cathode. At a cathode catalyst layer, oxygen reacts with the protons to form water. The anode and cathode reactions in this fuel cell are shown in the following equations:

Anode reaction (fuel side): CH₃OH+H₂O→6H⁺+CO₂+6e⁻ (I)

Cathode reaction (air side): 3/2 O₂+6H⁺+6e⁻→3H₂O (II)

Net: CH₃OH+3/2O₂→2H₂O+CO₂ (III)

One of the essential requirements of a fuel cell is efficient delivery of fuel to the electrodes. U.S. Pat. No. 5,631,099 describes a typical microchannel and plumbing design that facilitates the flow of fuel and removal of water during fuel cell operation. U.S. Pat. Nos. 5,766,786 and 6,280,867 describe pumping systems to accurately and reproducibly deliver the fuel to the electrodes. All these devices have complex arrangements of membrane, gaskets, channels that are difficult and expensive to fabricate and assemble, and are highly subject to catastrophic failure of the entire system if a leak develops. As can be easily appreciated, the cost of fabricating and assembling fuel cells is significant, due to the materials and labor involved. Typically, 85% of a fuel cell's cost is attributable to manufacturing costs. Thus, the complexity of prior art fuel cell structures is one of the factors preventing widespread acceptance of fuel cell technology. An improved style of fuel cell that is less complex and less prone to failure would be a significant addition to the field. With regard to fuel delivery systems in particular, there is a continuing need for a delivery system that can efficiently deliver fuels in a cost effective manner. A passive fuel delivery system with no plumbing and pumps would be highly desirable in applications such as portable fuel cells.

### SUMMARY

A method for delivering liquid fuel to a reaction surface in a fuel cell is disclosed. The liquid fuel is passively delivered to the reaction surface of an electrode by capillary force through an effective porous structure.

In an embodiment, the effective porous structure is inserted inside a fuel storage space of a fuel cell and delivers fuel to an electrode of the fuel cell through capillary effect.

In another embodiment, the effective porous structure is a part of a fuel cartridge. The fuel cartridge can be loaded into a cartridge holder in a fuel cell.

Additional advantages and novel features will be set forth in part in the description which follows, and in part will become apparent to those skilled in the art upon examination of the following or may be learned by practice of the invention.

### BRIEF DESCRIPTION OF THE DRAWINGS

The detailed description will refer to the following drawings, in which like numerals refer to like elements, and in which:

FIG. 1 is a schematic showing the capillary effect.

FIGS. 2A and 2B are schematics of porous structures for fuel delivery in a fuel cell.

FIG. 3 depicts a porous structure as part of a fuel cartridge.

FIGS. 4A, 4B and 4C depict an embodiment of fuel flow control between a fuel cartridge and a fuel cell.

FIGS. 5A and 5B depict another embodiment of fuel flow control between a fuel cartridge and a fuel cell.

### DETAILED DESCRIPTION

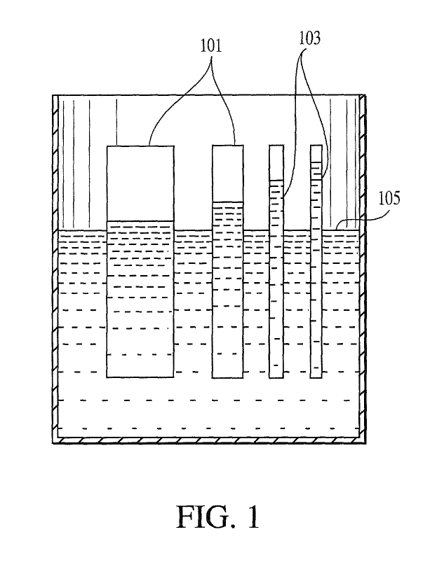

A passive fuel delivery system using capillary effect to deliver fuel to a reaction surface is disclosed. Capillary effect is the spontaneous rise of a liquid in a fine tube due to adhesion of the liquid to the inner surface of the tube and cohesion of the adhered liquid to and among other liquid molecules. FIG. 1 shows capillary effect in tubes of different sizes. As depicted, capillary rise is related to the diameter of tubes 101. The smaller is the tube diameter, the greater is the rise of a liquid column 103 from a liquid table 105. When a porous structure, such as a foam, is placed into a fuel container, the capillary effect of the small-diameter pores in the foam will cause the fuel to rise above the fuel level to form a capillary fringe in the foam. Typically, the capillary fringe is composed of pores of various sizes, from macropores to micropores. At the base of the capillary fringe, all the pores are saturated by the fuel. At the top of the capillary fringe, saturation by fuel is limited to only the micropores.

Capillary rise of fuel in a foam can be represented by the following equation:

ρgh=[2σ cos θₑ]/rₑ=P_{c}

where ρ is the density of the fuel, g is the gravitational constant, and h is the height the fuel has risen above the fuel level in a container in which the foam is standing. The symbol σ represents the surface tension of the fuel, θₑ is the effective equilibrium wetting angle of the fuel on the surface of the foam, rₑ is the effective pore radius of the foam, and P_{c} represents the capillary pressure. For any given fuel, ρ and g are both constant, and therefore h is inversely proportional to the pore radius rₑ, i.e., the smaller the pores are, the higher the fuel rises. In addition, a reduction of the wetting angle θₑ of the fuel on the foam will improve or increase the height that the fuel rises in the foam, assuming all other parameters remain constant. The wetting angle θₑ can be reduced by increasing the surface energy of surfaces throughout the foam. The surface energy can be increased by subjecting the foam to a free radical oxidation plasma process.

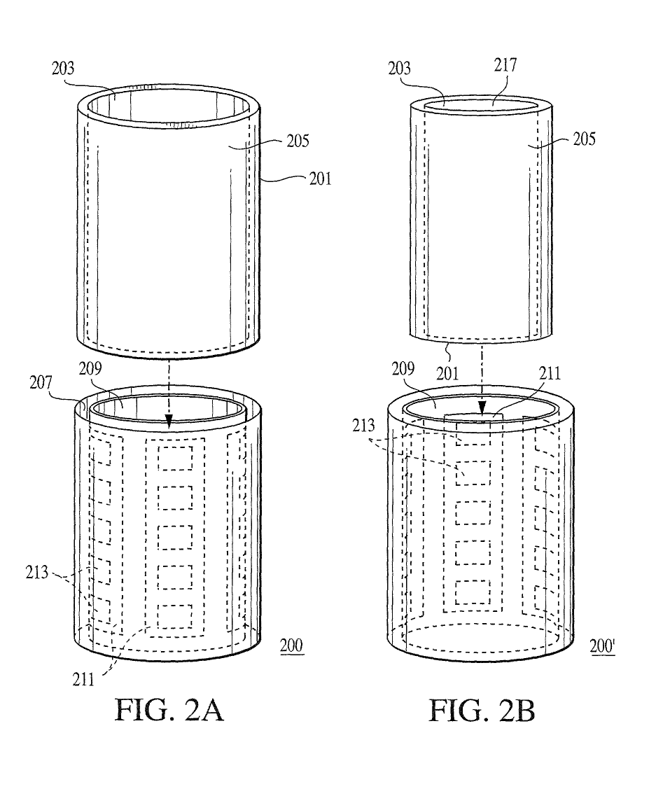

FIG. 2A depicts an embodiment of the fuel delivery system. In this embodiment, porous structure 201 is in the shape of a hollow tube so that the porous structure 201 can be inserted into outer cavity 207, which serves as fuel container for a flex based fuel cell 200. An inner surface 203 of the porous structure 201 is pressed against fuel electrodes 211 so that fuel can be delivered directly to reaction surfaces 213 of the fuel electrodes 211.

Typically, the porous structure 201 is in the form of a felted piece of polyurethane foam or other suitable porous materials. The foam is thermally compressed, or felted, until the foam holds a compression set at a desired compression ratio. During a thermal compressing process, the foam is heated close to its melting point under a compression loading and allowed to thereafter cool, resulting in a denser foam with an increased porosity. When so felted, the foam achieves an effective porosity.

Alternatively, As shown in FIG. 2B, the flex based fuel cell 200′ may be configured in such a way that the fuel electrodes 211 face the inner cavity 209. In this case, the porous structure 201 may be in the shape of a cylinder that can be inserted inside the inner cavity 209 of the flex based fuel cell 200. The outer surface 205 of the porous structure 201 is pressed against the reaction surfaces 213 of the fuel electrodes 211.

In both configurations, the capillary force at the surface of the porous structure 201 that contacts the electrodes 211 is higher than the capillary force in the other parts of the porous structure 201, so that fuel will be drawn to the electrodes 211. The higher capillary force can be achieved by (1) reducing the pore radius by increasing foam density, (2) reducing the wetting angle by increasing the surface energy of the foam, or both. Foam density can be increased by packing the foam denser along the outside peripheral of the porous structure 201. Surface energy of the foam can be increased by diffusing a chemically active species into the interior portion of a bulk polymer foam by subjecting the foam surface to special treatments such as a gas plasma process. The smaller pores in denser foam or reduced wetting angle will ensure that the fuel is drawn to the electrodes 211 by the higher capillary force, so that in the embodiment of FIG. 2B, even when the fuel inside the inner cavity 217 of the porous structure 201 starts to deplete, the fuel will still be transported to the electrodes 211 for efficient fuel utilization.

As can be appreciated by one skilled in the art, the foam insert 201 is designed for easy replacement and can be configured into any shape to adapt to different fuel cell configurations.

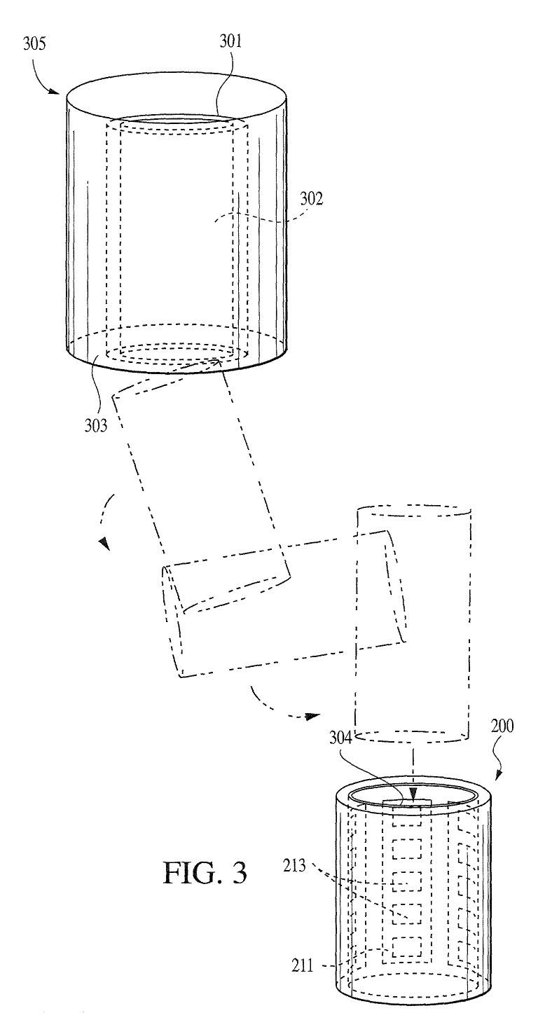

In another embodiment, the foam insert is used as a fuel cartridge 305. As shown in FIG. 3, fuel 302 is contained inside a sealed foam cylinder 301, which is kept in a non-permeable container 303 or is wrapped with a non-permeable material. When needed, the cylinder 301 is taken out from the container 303 or from the wrapping material and is loaded into a cartridge holder 304 of a fuel cell 200. In yet another embodiment, the fuel cylinder 301 is tightly wrapped with a non-permeable material to form cartridge 305, which can be directly loaded into a fuel cell 200 without removing the wrapping thereby avoiding leakage of fuel from the cylinder 301 during the loading process.

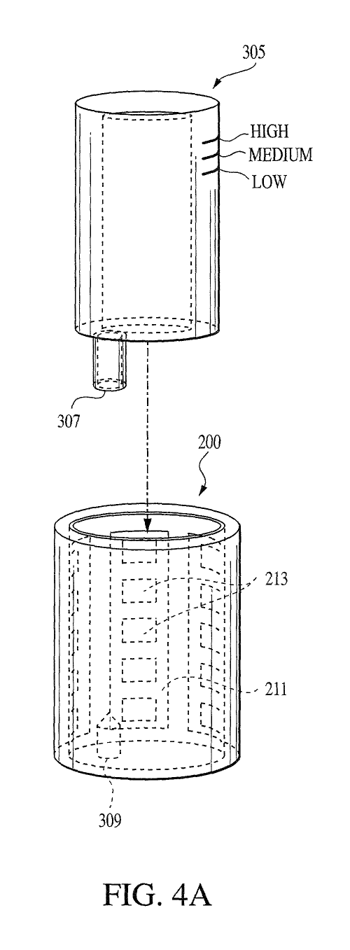

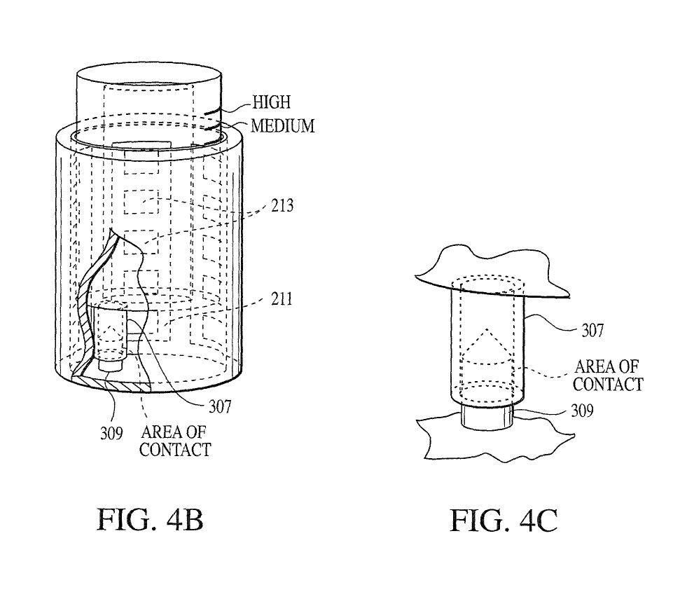

The fuel in the cartridge 305 enters the fuel cell 200 through one or more connectors 307 (FIG. 4A). The connector 307 can be in different shapes and sizes. Typically, the connector 307 is made of foam materials that provide higher capillary force than the rest of the fuel cartridge, so that fuel in the cartridge 305 will be drawn to the connector 307 by the capillary force. In one embodiment, the connector 307 is in the shape of a short tubing and is located at the bottom of the fuel cartridge 305 (FIG. 4A).

When the fuel cartridge 305 is loaded into the fuel cell 200, a needle-like receptacle 309 in the fuel cell 200 penetrates the non-permeable wrapping material at the end of the connector 307. The base of the receptacle 309 is connected to the electrodes 211 through a porous material that establishes a capillary passage way between the fuel cartridge 305 and the electrodes 211 (FIG. 4B). In this embodiment, the needle-like receptacle 309 is also made of a porous material so that the fuel flow can be controlled by the size of a contact area between the needle-like receptacle 309 and the connector 307 (FIG. 4C). As shown in FIG. 4B, the fuel flow rate between fuel cartridge 305 and fuel cell 200 is controlled by positioning the fuel cartridge 305 at the high, medium, or low mark on the side of the cartridge 305.

Generally, the needle-like receptacle 309 is made of a porous material having a capillary force that is stronger than the capillary force in the connector 307, while the porous material in contact with the electrode 211 has a capillary force that is stronger than capillary force in receptacle 309. This capillary force gradient ensures that the fuel inside the fuel cartridge 305 flows preferentially to the connector 307, then to the receptacle 309, and finally to the electrode 211.

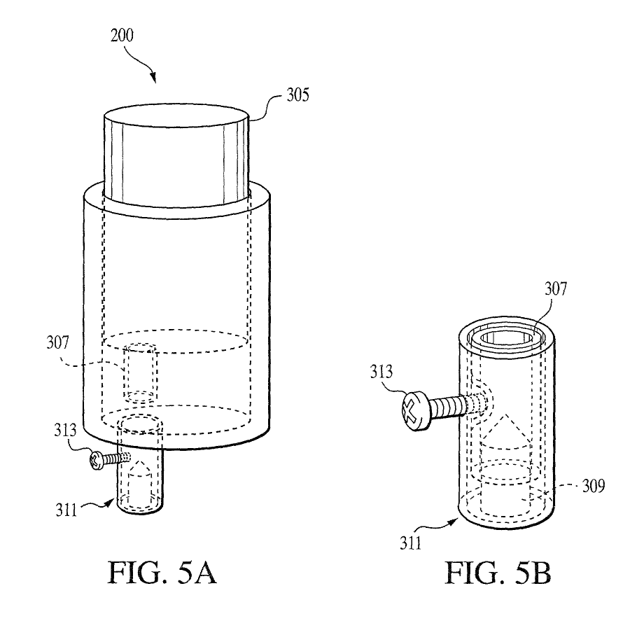

In another embodiment, a controller 311 is located at the bottom of the fuel cell 200 (FIG. 5A). The fuel flows from the cartridge 305 to the fuel cell 200 through the contact between the connector 307 and receptacle 309, which is connected to electrodes by porous materials. The controller 311 controls a cross sectional area of the connector 307 by applying a pressure to the connector 307 through a screw 313 (FIG. 5B). A fuel flow is restricted by advancing the screw 313 towards the connector 307, thereby reducing the cross sectional area of the connector 307.

Alternatively, the fuel flow from the cartridge 305 to fuel cell 200 can be controlled by a conventional electromagnetic valve.

Although embodiments and their advantages have been described in detail, various changes, substitutions and alterations can be made herein without departing from the spirit and scope of the fuel delivery system as defined by the appended claims and their equivalents.

In the claims:

1. An apparatus for fuel delivery in a liquid-type fuel cell, comprising:
an effective porous structure in a shape that fits a fuel storage space of a liquid-type fuel cell, said effective porous structure, when placed inside a fuel cell having a fuel and an electrode, is capable of delivering said fuel to said electrode through capillary effect.

2. The apparatus of claim 1, wherein the effective porous structure has a first surface that contacts the electrode, and wherein porous material adjacent the first surface provides a first capillary force that is stronger than a second capillary force in the effective porous structure not adjacent the first surface.

3. The apparatus of claim 2, wherein the first capillary force is achieved by increasing a density of the porous material adjacent the first surface of the effective porous structure or by reducing a wetting angle of the fuel on the porous material adjacent the first surface of the effective porous structure.

4. The apparatus of claim 3, wherein the wetting angle is reduced by increasing a surface energy of internal surfaces throughout the porous material adjacent the first surface of the effective porous structure using a gas plasma treatment process.

5. The apparatus of claim 1, wherein the liquid-type fuel cell is a flex based fuel cell and the effective porous structure is in a shape of a hollow tube or a cylinder.

6. The apparatus of claim 1, wherein the effective porous structure is in a shape of a sealed cylinder and is filled with the fuel.

7. The apparatus of claim 1, wherein the effective porous structure is a foam structure.

8. A fuel cartridge for a liquid-type fuel cell, comprising:
a fuel;
an effective porous structure; and
a non-permeable member,
wherein said fuel is stored in the said effective porous structure, said effective porous structure is adapted to be placed into a fuel cell and wherein said effective porous structure provides fuel for said fuel cell through capillary effect.

9. The fuel cartridge of claim 8, wherein the effective porous structure is a foam structure.

10. The fuel cartridge of claim 8, further comprising a connector,
wherein said connector establishes a fuel passageway between said fuel cartridge and said fuel cell when said fuel cartridge is placed into said fuel cell.

11. The fuel cartridge of claim 10, wherein a fuel flow through the fuel passageway is controlled by a position of said fuel cartridge with respect to said fuel cell.

12. A fuel cell having a passive fuel delivery system, said fuel cell comprising:
a fuel;
an electrode; and
an effective porous structure having contact to both the fuel and the electrode,
wherein said porous structure is capable of delivering the fuel to the electrode through capillary effect.

13. A fuel cell having a passive fuel delivery system, said fuel cell comprising:
an electrode; and
a cartridge holder,
wherein said cartridge holder holds a fuel cartridge and establishes a capillary passageway between said fuel cell and said fuel cartridge, and wherein said capillary passageway allows a flow of a fuel from the fuel cartridge to the electrode through capillary effect.

14. The fuel cell of claim 13, further comprising a receptacle, wherein said receptacle interacts with a connector on the fuel cartridge and establishes a capillary passageway between said fuel cell and said fuel cartridge.

15. The fuel cell of claim 14, further comprising means for controlling a fuel flow rate between said fuel cartridge and said fuel cell.

16. The fuel cell of claim 15, wherein the fuel flow rate is controlled by adjusting a contact area between said receptacle and said connector.

17. The fuel cell of claim 15, wherein the means for controlling fuel flow comprises a controller, said controller controls the fuel flow rate by adjusting a cross sectional area in said connector.

18. The fuel cell of claim 15, wherein the means for controlling fuel flow is an electromagnetic valve.

19. A method for delivering fuel in a fuel cell, comprising:
providing a fuel;
providing a fuel cell having an electrode;
providing an effective porous structure; and
placing the effective porous structure in the fuel cell in such a position that the fuel moves through the effective porous structure towards the electrode by capillary force.

20. The method of claim 19, wherein the effective porous structure has a capillary force distribution that facilitates a flow of the fuel from the effective porous structure towards the electrode.

21. A method for delivering fuel in a fuel cell, comprising:
providing a fuel cell comprising an electrode and a cartridge holder;
providing a fuel cartridge having an effective porous structure; and
placing the fuel cartridge into the cartridge holder of the fuel cell to establish a contact between the fuel cartridge and the fuel cell,
wherein the contact allows a fuel flow from the fuel cartridge to the fuel cell, and wherein the fuel flow is driven by capillary force.

22. The method of claim 21, wherein the contact between the fuel cartridge and the fuel cell is established through interaction between a connector on the fuel cartridge and a receptacle in the fuel cell.

23. The method of claim 22, further comprising:
controlling a rate of fuel flow from the fuel cartridge to the fuel cell with a controller.
